(19) United States
(12) Patent Application Publication
(10) Pub. No.: US 2025/0226666 A1
(43) Pub. Date: Jul. 10, 2025

(54) METHOD FOR CONTROLLING COORDINATED OPERATION OF MULTIPLE WIND GENERATORS TO AVOID SECONDARY FREQUENCY DROP

(71) Applicant: Changsha University of Science and Technology, Changsha (CN)

(72) Inventors: Yanjian Peng, Changsha (CN); Yijia Cao, Changsha (CN); Yong Li, Changsha (CN); Fanrui Chang, Changsha (CN); Jiajun Li, Changsha (CN); Xingyu Shi, Changsha (CN); Junjie Zhong, Changsha (CN)

(21) Appl. No.: 19/092,221

(22) Filed: Mar. 27, 2025

(30) Foreign Application Priority Data
Nov. 1, 2024 (CN) 202411552996.7

(51) Int. Cl. H02J 3/38; F03D 7/04; H02P 9/00; H02P 101/15

(52) U.S. Cl. CPC H02J 3/38; F03D 7/048; H02P 9/007; F05B 2270/101; F05B 2270/327; F05B 2270/337; H02J 2300/28; H02P 2101/15

(57) ABSTRACT

The present disclosure discloses a method for controlling coordinated operation of multiple wind generators to avoid secondary frequency drop. The method includes the following steps: first, the Doubly Fed Induction Generator (DFIG) required for frequency support is dynamically selected based on a real-time disturbance power of a power grid and the rotating speed level of each DFIG; second, the virtual inertial control parameters are adaptively regulated according to the system frequency and the change in the rotating speed of the DFIG participating in frequency support, ensuring that the frequency support requirements are satisfied; and finally, the remaining DFIGs are controlled to release the rotor kinetic energy to support the rotating speed recovery of the selected DFIG, so as to reduce the extra energy absorbed from the power grid in the process.

### TECHNICAL FIELD

The present disclosure relates to the technical field of renewable energy integration and control, and in particular to a method for controlling coordinated operation of multiple wind generators to avoid secondary frequency drop.

### BACKGROUND

As an important part of renewable energy power generation, wind power has the characteristics of being clean and environmentally friendly, highly adaptable to different regions, and low in operation cost, which has developed rapid in recent years. A Doubly Fed Induction Generator (DFIG) is a mainstream model of wind power generation. Because the DFIG rotor is connected to the power grid through the converter, the rotating speed and the frequency of the rotor are completely decoupled, which cannot effectively respond to the system frequency change. With the increasing wind power permeability, the system frequency stability is decreasing.

In the prior art, in order to improve the frequency active support capability of the DFIG after the DFIG is connected to the grid, the DFIG can release the rotor kinetic energy for frequency support at the time of frequency drop through additional power control, and after withdrawing from the frequency response, the DFIG needs to absorb energy for recovering the rotating speed. If too much extra energy is absorbed from the power grid, it is easy to result in the secondary frequency drop of the system. Moreover, the rotor kinetic energy level of each DFIG in the wind farm is different. Therefore, the excessive use of the rotor kinetic energy will aggravate the problem of secondary frequency drop, and cause the DFIG with a lower rotating speed to withdraw from operation.

### SUMMARY

In view of the shortcomings in the prior art, the purpose of the present disclosure is to provide a method for controlling coordinated operation of multiple wind generators to avoid secondary frequency drop, so as to solve the problems in the above background. The present disclosure can effectively avoid excessive release of the rotor kinetic energy of the DFIG in the process while ensuring the frequency support effect, thereby reducing the possibility of secondary frequency drop, greatly reducing the energy absorbed from the power grid, and avoiding the occurrence of secondary frequency drop.

In order to achieve the above purpose, the present disclosure is realized through the following technical scheme. A method for controlling coordinated operation of multiple wind generators to avoid secondary frequency drop includes the following steps:
S1, acquiring equivalent parameters of a system frequency response model through offline massive data, and dynamically selecting a Doubly Fed Induction Generator (DFIG) required to participate in frequency support after detecting online that a system frequency deviation exceeds a threshold;
S2, comparing the number of the selected DFIGs with the total number of the DFIGs, and performing adaptive virtual inertia control based on the frequency change and a rotor kinetic energy of each DFIG participating in frequency support to guarantee a frequency support effect;
S3, if the number of the selected DFIGs is less than the total number of DFIGs, controlling the unselected DFIGs to release the stored rotor kinetic energy within a certain period of time to support the rotating speed recovery of each DFIG during a rotating speed recovery stage, and then all DFIGs entering the rotating speed recovery stage until the rotating speed is recovered to an initial value, otherwise all DFIGs entering the rotating speed recovery stage after ending the frequency support.

Further, the offline massive data in Step S1 includes historical frequency drop, load disturbance data, the number n of DFIGs and a wind power permeability ρ of a system, and equivalent parameters of the system frequency response model include a regulation deviation coefficient R of a synchronous machine in the case of equivalent values, a reheat time constant T_{RH} of a steam turbine, a high-pressure cylinder power ratio coefficient F_{HP}, a system equivalent inertia time constant H_{S} and an equivalent damping coefficient D.

Further, a power grid frequency deviation Δf satisfies the following relational expression:

$$Δ f = f - {f}_{N}$$

where f is an actual measured frequency of the power grid, and f_{N} is a rated frequency of the power grid; and the threshold of the system frequency deviation in Step S1 is ±0.02 Hz.

Further, the process of dynamically selecting the DFIG participating in frequency support in Step S1 is as follows: when |Δf|≥0.02 Hz, setting initial values K_{Di,0} and K_{Ii,0} of the virtual inertia control parameters of each DFIG, arranging each DFIG in a descending order according to the rotating speed, and selecting k=1 to start iteration of the effect of each selected DFIG participating in frequency support, which is expressed by the following formula:

$$\{ \begin{matrix}{t}_{nadir , k} = \frac{1}{ω \sqrt{1 - {ξ}^{2}}} arctan ( \frac{ω \sqrt{1 - {ξ}^{2}} {T}_{RH}}{ω ξ {T}_{RH} - 1} ) \\ Δ {f}_{max , k} = \frac{R Δ {P}_{L}}{( D + ρ {\sum }_{i = 1}^{k} {K}_{Di} ) R + 1} ( 1 + \sqrt{1 - {ξ}^{2}} α {e}^{- ξ ω {t}_{nadir}} ) \\ {\vert \frac{d Δ f ( t )}{dt} \vert}_{max , k} = \frac{αω R Δ {P}_{L}}{( D + ρ {\sum }_{i = 1}^{k} {K}_{Di} ) R + 1} [ ξ sin φ - \sqrt{1 - {ξ}^{2}} cos φ ]\end{matrix}$$

Further, after calculating results of each iteration, it is necessary to compare the results with system frequency support constraints, and when the conditions shown in the following formula are satisfied, iteration stops to acquire k DFIGs satisfying the frequency support requirements:

$$\{ \begin{matrix}Δ {f}_{max , k} \leq Δ {f}_{m} \\ {\vert \frac{d Δ f ( t )}{dt} \vert}_{max , k} \leq {\vert \frac{d Δ f ( t )}{dt} \vert}_{m} \{\end{matrix}$$

where Δfₘ and |dΔf(t)/dt|ₘ are the maximum allowable frequency drop and maximum allowable frequency change value in the process of the system frequency change, respectively.

Further, a threshold ε is set to fully guarantee a frequency support level, and k=k+ε is set.

Further, comparing the number of the selected DFIGs with the total number of the DFIGs in Step S2 indicates that the number of the selected DFIGs is compared with the total number n of the DFIGs in a wind farm, if k<n, only this part of DFIGs needs to be called to participate in frequency modulation, otherwise all DFIGs in the wind farm need to be fully called for frequency support.

Further, the adaptive virtual inertia control of the DFIG indicates that the virtual inertia control parameters K_{Di,0} and K_{Ii,0} of each DFIG are adaptively regulated according to the real-time frequency change and the rotation speed:

$${K}_{Di} = \{ \begin{matrix}{K}_{Di , 0} exp ( 2 \frac{{ω}_{r , i}^{2} - {ω}_{r , min}^{2}}{{}_{{ω}_{r , max}}^{{2}_{r , min}^{2}} \vert \frac{df}{dt} \vert {( )}_{nadir}} \vert 0 , t > {t}_{nadir} ) \\ {K}_{Ii} = \{ {K}_{Ii , 0} exp ( 2 \frac{{ω}_{r , i}^{2} - {ω}_{r , min}^{2}}{{}_{{ω}_{r , max}}^{{2}_{r , min}^{2}} \vert \frac{df}{dt} \vert {( )}_{nadir}} \vert 0 , t > {t}_{nadir} )\end{matrix}$$

where ω_{r,max} and ω_{r,min} are the maximum value and the minimum value of the rotating speed when the DFIG is capable of operating stably, respectively.

Further, when the number of the selected DFIGs is less than the total number of DFIGs in Step S3, t₁ and t₂ are set as the start time and the exit time of the frequency support, respectively, only k DFIGs are dynamically selected to release the rotor kinetic energy in (t₁, t₂) period of time, k DFIGs start to recover the rotating speed after t₂, the remaining n-k DFIGs that do not participate in the frequency support stage serve as second DFIGs to release the rotor kinetic energy in (t₂, t₂+5) period of time, the additional power control parameters are set as the initial values K_{Di,0} and K_{Ii,0}, and then all DFIGs enter the rotating speed recovery stage and recovers the rotating speed to the initial value after t₂+5.

The present disclosure has the following beneficial effects.

1. According to the present disclosure, the number of DFIGs required for frequency support is dynamically selected through a real-time disturbance power and a rotating speed level of each DFIG. Virtual inertial control parameters are adaptively regulated according to a system frequency and the change of the rotating speed of the DFIG participating in frequency support to satisfy frequency support requirements. The remaining DFIGs are controlled to release the rotor kinetic energy to support the rotating speed recovery of the selected DFIG, so as to reduce the extra energy absorbed from the power grid in the process.

2. The method for controlling coordinated operation of multiple wind generators to avoid secondary frequency drop can effectively avoid excessive release of the rotor kinetic energy of the DFIG in the process while ensuring the frequency support effect, thereby reducing the possibility of secondary frequency drop, and providing technical support for the operation of the high-proportion renewable energy grid.

### BRIEF DESCRIPTION OF THE DRAWINGS

FIG. 1 is a flow chart of a method for controlling coordinated operation of multiple wind generators.

FIG. 2 is a diagram of the DFIG adaptive virtual inertia control.

FIG. 3 is a schematic diagram of rotor kinetic energy interaction between two groups of DFIGs.

### DETAILED DESCRIPTION OF THE EMBODIMENTS

In order to make the technical means, creative features, goals and effects of the present disclosure understandable, the present disclosure will be further elaborated with reference to detailed description.

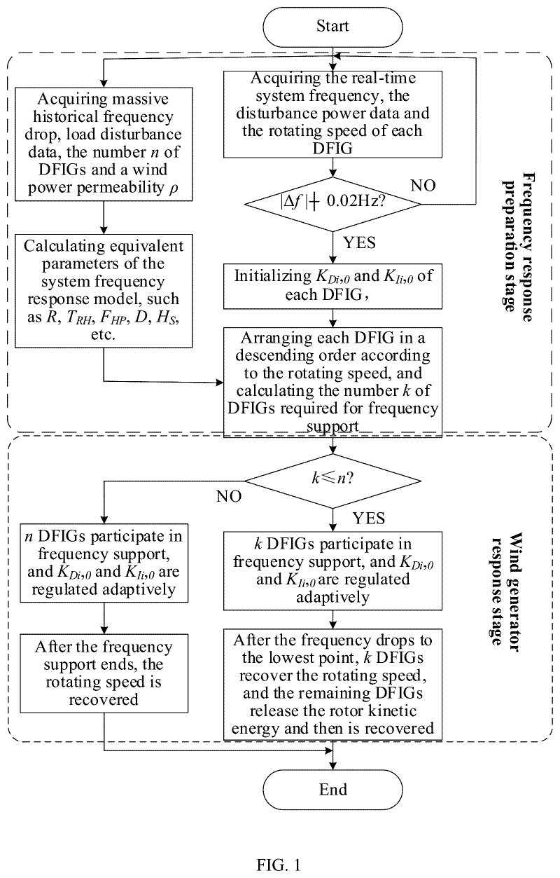

As shown in FIG. 1 to FIG. 3, the present disclosure provides the following technical scheme: a method for controlling coordinated operation of multiple wind generators to avoid secondary frequency drop. The specific scheme is as follows.

First, the power grid frequency deviation is calculated according to the real-time monitoring of the frequency change of the power grid, and it is judged whether the power grid needs frequency modulation. If so, the number of DFIGs required for frequency support is dynamically selected through a real-time disturbance power of a power grid and a rotating speed level of each DFIG. Virtual inertial control parameters are adaptively regulated according to a system frequency and the change of the rotating speed of the DFIG participating in frequency support to satisfy frequency support requirements. Finally, the remaining DFIGs are controlled to release the rotor kinetic energy to support the rotating speed recovery of the selected DFIG, so as to reduce the extra energy absorbed from the power grid in the process, and reduce the probability of secondary frequency drop and excessive drop of the rotating speed of the DFIG.

In order to better understand the above technical scheme, the above technical scheme will be explained in detail with reference to the attached drawings and the detailed description hereinafter.

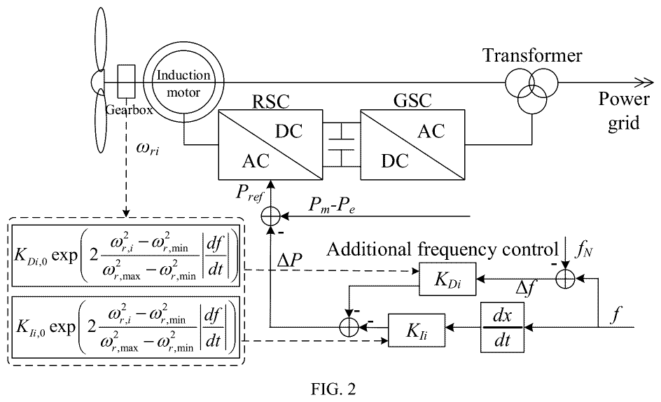

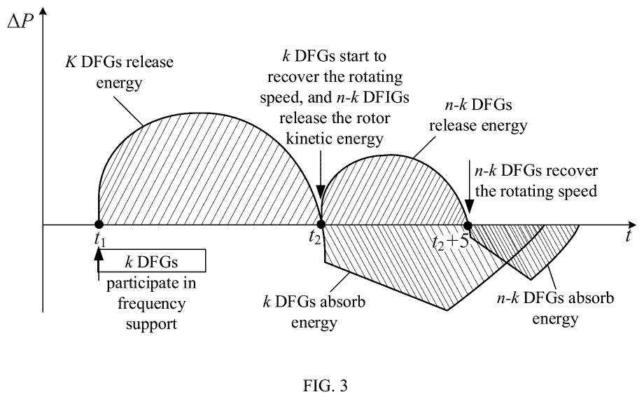

As shown in FIG. 1, FIG. 2 and FIG. 3, an embodiment of the present disclosure provides a primary frequency modulation method of a doubly fed induction generator based on a variable rotating speed coefficient, which specifically includes the following steps.

S1, equivalent parameters of a system frequency response model are acquired through offline massive data, and a DFIG required to participate in frequency support is dynamically selected after detecting online that a system frequency deviation exceeds a threshold.

Specifically, as shown in FIG. 1, the offline massive data includes historical frequency drop, load disturbance data, the number n of DFIGs and a wind power permeability ρ of a system. Equivalent parameters of the system frequency response model include a regulation deviation coefficient R of a synchronous machine in the case of equivalent values, a reheat time constant T_{RH} of a steam turbine, a high-pressure cylinder power ratio coefficient F_{HP}, a system equivalent inertia time constant H_{S} and an equivalent damping coefficient D, etc. A power grid frequency deviation Δf satisfies the following relational expression:

$$Δ f = f - {f}_{N}$$

where f is an actual measured frequency of the power grid, and f_{N} is a rated frequency of the power grid; and the threshold of the system frequency deviation is ±0.02 Hz.

The process of dynamically selecting the DFIG participating in frequency support is as follows: when |Δf|≥0.02 Hz, setting initial values K_{Di,0} and K_{Ii,0} of the virtual inertia control parameters of each DFIG, arranging each DFIG in a descending order according to the rotating speed, and selecting k=1 to start iteration of the effect of each selected DFIG participating in frequency support, which is expressed by the following formula:

$$\{ \begin{matrix}{t}_{nadir , k} = \frac{1}{ω \sqrt{1 - {ξ}^{2}}} arctan ( \frac{ω \sqrt{1 - {ξ}^{2}} {T}_{RH}}{ω ξ {T}_{RH} - 1} ) \\ Δ {f}_{max , k} = \frac{R Δ {P}_{L}}{( D + ρ {\sum }_{i = 1}^{k} {K}_{Di} ) R + 1} ( 1 + \sqrt{1 - {ξ}^{2}} α {e}^{- ξ ω {t}_{nadir}} ) \\ {\vert \frac{d Δ f ( t )}{dt} \vert}_{max , k} = \frac{αω R Δ {P}_{L}}{( D + ρ {\sum }_{i = 1}^{k} {K}_{Di} ) R + 1} [ ξ sin φ - \sqrt{1 - {ξ}^{2}} cos φ ]\end{matrix}$$

After calculating results of each iteration, it is necessary to compare the results with system frequency support constraints, and when the conditions shown in the following formula are satisfied, iteration stops to acquire k DFIGs satisfying the frequency support requirements:

$$\{ \begin{matrix}Δ {f}_{max , k} \leq Δ {f}_{m} \\ {\vert \frac{d Δ f ( t )}{dt} \vert}_{max , k} \leq {\vert \frac{d Δ f ( t )}{dt} \vert}_{m} \{\end{matrix}$$

where Δfₘ and |dΔf(t)/dt|ₘ are the maximum allowable frequency drop and maximum allowable frequency change value in the process of the system frequency change, respectively. Considering the accuracy of iteration and the better frequency support effect, a threshold ε is set to fully guarantee a frequency support level, and k=k+ε is set.

S2, the number of the selected DFIGs is compared with the total number of the DFIGs, and adaptive virtual inertia control is performed based on the frequency change and a rotor kinetic energy of each DFIG participating in frequency support to guarantee a frequency support effect.

Specifically, as shown in FIG. 2, the number k of the selected DFIGs is compared with the total number n of the DFIGs. If k<n, only this part of DFIGs needs to be called to participate in frequency modulation, otherwise all DFIGs in the wind farm need to be fully called for frequency support. The adaptive virtual inertia control of the DFIG indicates that the virtual inertia control parameters K_{Di,0} and K_{Ii,0} of each DFIG are adaptively regulated according to the real-time frequency change and the rotation speed:

$${K}_{Di} = \{ \begin{matrix}{K}_{Di , 0} exp ( 2 \frac{{ω}_{r , i}^{2} - {ω}_{r , min}^{2}}{{}_{{ω}_{r , max}}^{{2}_{r , min}^{2}} \vert \frac{df}{dt} \vert {( )}_{nadir}} \vert 0 , t > {t}_{nadir} ) \\ {K}_{Ii} = \{ {K}_{Ii , 0} exp ( 2 \frac{{ω}_{r , i}^{2} - {ω}_{r , min}^{2}}{{}_{{ω}_{r , max}}^{{2}_{r , min}^{2}} \vert \frac{df}{dt} \vert {( )}_{nadir}} \vert 0 , t > {t}_{nadir} )\end{matrix}$$

where ω_{r,max} and ω_{r,min} are the maximum value and the minimum value of the rotating speed when the DFIG is capable of operating stably, respectively.

S3, if the number of the selected DFIGs is less than the total number of DFIGs, the unselected DFIGs are controlled to release the stored rotor kinetic energy within a certain period of time to support the rotating speed recovery of each DFIG during a rotating speed recovery stage, and then all DFIGs enter the rotating speed recovery stage until the rotating speed is recovered to an initial value. Otherwise all DFIGs enter the rotating speed recovery stage after ending the frequency support.

Specifically, as shown in FIG. 3, in the case of k<n, it is assumed that t₁ and t₂ are set as the start time and the exit time of the frequency support, respectively, only k DFIGs are dynamically selected to release the rotor kinetic energy in (t₁, t₂) period of time, k DFIGs start to recover the rotating speed after t₂, the remaining n−k DFIGs that do not participate in the frequency support stage serve as second DFIGs to release the rotor kinetic energy in (t₂, t₂+5) period of time, the additional power control parameters are set as the initial values K_{Di,0} and K_{Ii,0}, and then all DFIGs enter the rotating speed recovery stage and recovers the rotating speed to the initial value after t₂+5.

The basic principles, main features and advantages of the present disclosure have been shown and described above. It is obvious to those skilled in the art that the present disclosure is not limited to the details of the above exemplary embodiments. Moreover, the present disclosure can be realized in other specific forms without departing from the spirit or basic features of the present disclosure.

In addition, it should be understood that although this specification is described in terms of embodiments, not every embodiment only contains an independent technical scheme. The description of the specification is only for the sake of clarity. Those skilled in the art should take the specification as a whole, and the technical schemes in various embodiments can also be appropriately combined to form other embodiments that can be understood by those skilled in the art.

What is claimed is:

1. A method for controlling coordinated operation of multiple wind generators to avoid secondary frequency drop, comprising the following steps:
S1, acquiring equivalent parameters of a system frequency response model through offline massive data, and dynamically selecting a Doubly Fed Induction Generator (DFIG) required to participate in frequency support after detecting online that a system frequency deviation exceeds a threshold;
S2, comparing the number of the selected DFIGs with the total number of the DFIGs, and performing adaptive virtual inertia control based on the frequency change and a rotor kinetic energy of each DFIG participating in frequency support to guarantee a frequency support effect;
S3, if the number of the selected DFIGs is less than the total number of DFIGs, controlling the unselected DFIGs to release the stored rotor kinetic energy within a certain period of time to support the rotating speed recovery of each DFIG during a rotating speed recovery stage, and then all DFIGs entering the rotating speed recovery stage until the rotating speed is recovered to an initial value, otherwise all DFIGs entering the rotating speed recovery stage after ending the frequency support.

2. The method for controlling coordinated operation of multiple wind generators to avoid secondary frequency drop according to claim 1, wherein the offline massive data in Step S1 comprises historical frequency drop, load disturbance data, the number n of DFIGs and a wind power permeability ρ of a system, and equivalent parameters of the system frequency response model comprise a regulation deviation coefficient R of a synchronous machine in the case of equivalent values, a reheat time constant T_{RH} of a steam turbine, a high-pressure cylinder power ratio coefficient F_{HP}, a system equivalent inertia time constant H_{S} and an equivalent damping coefficient D.

3. The method for controlling coordinated operation of multiple wind generators to avoid secondary frequency drop according to claim 2, wherein a power grid frequency deviation Δf satisfies the following relational expression:
$$Δ f = f - {f}_{N}$$
where f is an actual measured frequency of the power grid, and f_{N} is a rated frequency of the power grid; and the threshold of the system frequency deviation in Step S1 is ±0.02 Hz.

4. The method for controlling coordinated operation of multiple wind generators to avoid secondary frequency drop according to claim 1, wherein the process of dynamically selecting the DFIG participating in frequency support in Step S1 is as follows: when |Δf|≥0.02 Hz, setting initial values K_{Di,0} and K_{Ii,0} of the virtual inertia control parameters of each DFIG, arranging each DFIG in a descending order according to the rotating speed, and selecting k=1 to start iteration of the effect of each selected DFIG participating in frequency support, which is expressed by the following formula:
$$\{ \begin{matrix}{t}_{nadir , k} = \frac{1}{ω \sqrt{1 - {ξ}^{2}}} arctan ( \frac{ω \sqrt{1 - {ξ}^{2}} {T}_{RH}}{ω ξ {T}_{RH} - 1} ) \\ Δ {f}_{max , k} = \frac{R Δ {P}_{L}}{( D + ρ {\sum }_{i = 1}^{k} {K}_{Di} ) R + 1} ( 1 + \sqrt{1 - {ξ}^{2}} α {e}^{- ξ ω {t}_{nadir}} ) \\ {\vert \frac{d Δ f ( t )}{dt} \vert}_{max , k} = \frac{αω R Δ {P}_{L}}{( D + ρ {\sum }_{i = 1}^{k} {K}_{Di} ) R + 1} [ ξ sin φ - \sqrt{1 - {ξ}^{2}} cos φ ]\end{matrix}$$

5. The method for controlling coordinated operation of multiple wind generators to avoid secondary frequency drop according to claim 4, wherein after calculating results of each iteration, it is necessary to compare the results with system frequency support constraints, and when the conditions shown in the following formula are satisfied, iteration stops to acquire k DFIGs satisfying the frequency support requirements:
$$\{ \begin{matrix}Δ {f}_{max , k} \leq Δ {f}_{m} \\ {\vert \frac{d Δ f ( t )}{dt} \vert}_{max , k} \leq {\vert \frac{d Δ f ( t )}{dt} \vert}_{m} \{\end{matrix}$$
where Δfₘ and |dΔf(t)/dt|ₘ are the maximum allowable frequency drop and maximum allowable frequency change value in the process of the system frequency change, respectively.

6. The method for controlling coordinated operation of multiple wind generators to avoid secondary frequency drop according to claim 5, wherein a threshold ε is set to fully guarantee a frequency support level, and k=k+ε is set.

7. The method for controlling coordinated operation of multiple wind generators to avoid secondary frequency drop according to claim 1, wherein comparing the number of the selected DFIGs with the total number of the DFIGs in Step S2 indicates that the number of the selected DFIGs is compared with the total number n of the DFIGs in a wind farm, if k<n, only this part of DFIGs needs to be called to participate in frequency modulation, otherwise all DFIGs in the wind farm need to be fully called for frequency support.

8. The method for controlling coordinated operation of multiple wind generators to avoid secondary frequency drop according to claim 7, wherein the adaptive virtual inertia control of the DFIG indicates that the virtual inertia control parameters K_{Di,0} and K_{Ii,0} of each DFIG are adaptively regulated according to the real-time frequency change and the rotation speed:
$${K}_{Di} = \{ \begin{matrix}{K}_{Di , 0} exp ( 2 \frac{{ω}_{r , i}^{2} - {ω}_{r , min}^{2}}{{}_{{ω}_{r , max}}^{{2}_{r , min}^{2}} \vert \frac{df}{dt} \vert {( )}_{nadir}} \vert 0 , t > {t}_{nadir} ) \\ {K}_{Ii} = \{ {K}_{Ii , 0} exp ( 2 \frac{{ω}_{r , i}^{2} - {ω}_{r , min}^{2}}{{}_{{ω}_{r , max}}^{{2}_{r , min}^{2}} \vert \frac{df}{dt} \vert {( )}_{nadir}} \vert 0 , t > {t}_{nadir} )\end{matrix}$$
where ω_{r,max} and ω_{r,min} are the maximum value and the minimum value of the rotating speed when the DFIG is capable of operating stably, respectively.

9. The method for controlling coordinated operation of multiple wind generators to avoid secondary frequency drop according to claim 1, wherein when the number of the selected DFIGs is less than the total number of DFIGs in Step S3, t₁ and t₂ are set as the start time and the exit time of the frequency support, respectively, only k DFIGs are dynamically selected to release the rotor kinetic energy in (t₁, t₂) period of time, k DFIGs start to recover the rotating speed after t₂, the remaining n−k DFIGs that do not participate in the frequency support stage serve as second DFIGs to release the rotor kinetic energy in (t₂, t₂+5) period of time, the additional power control parameters are set as the initial values K_{Di,0} and K_{Ii,0}, and then all DFIGs enter the rotating speed recovery stage and recovers the rotating speed to the initial value after t₂+5.
